(19) United States
(12) Patent Application Publication
(10) Pub. No.: US 2010/0233476 A1
(43) Pub. Date: Sep. 16, 2010

(54) Copper foil with primer resin layer and laminated sheet using the same

(76) Inventors: Makoto Uchida, Kita-ku (JP); Ryutaro Tanaka, Kita-ku (JP); Shigeo Hayashimoto, Kita-ku (JP); Shigeru Moteki, Kita-ku (JP); Mitsuyo Nishitoh, Kita-ku (JP)

Correspondence Address: Nields, Lemack & Frame, LLC, 176 E. Main Street, Suite #5, Westborough, MA, 01581, US

(21) Appl. No.: 12/308,308

(22) PCT Filed: Jun. 19, 2007
(86) PCT No.: PCT/JP2007/062266

§ 371 Date: Dec. 12, 2008

(30) Foreign Application Priority Data
Jun. 20, 2006 (JP) 2006-170668

(51) Int. Cl. B32B 15/088; C08L 79/04; C08L 81/06

(52) U.S. Cl. 428/344; 524/611; 524/609; 524/592

(57) ABSTRACT

The present invention relates to a copper foil having a primer resin layer which improves the adhesive strength between a copper foil surface without roughening treatment and a substrate resin and a laminated sheet using the same and is characterized by using a polyimide represented by the following formula (1):

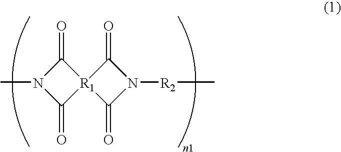

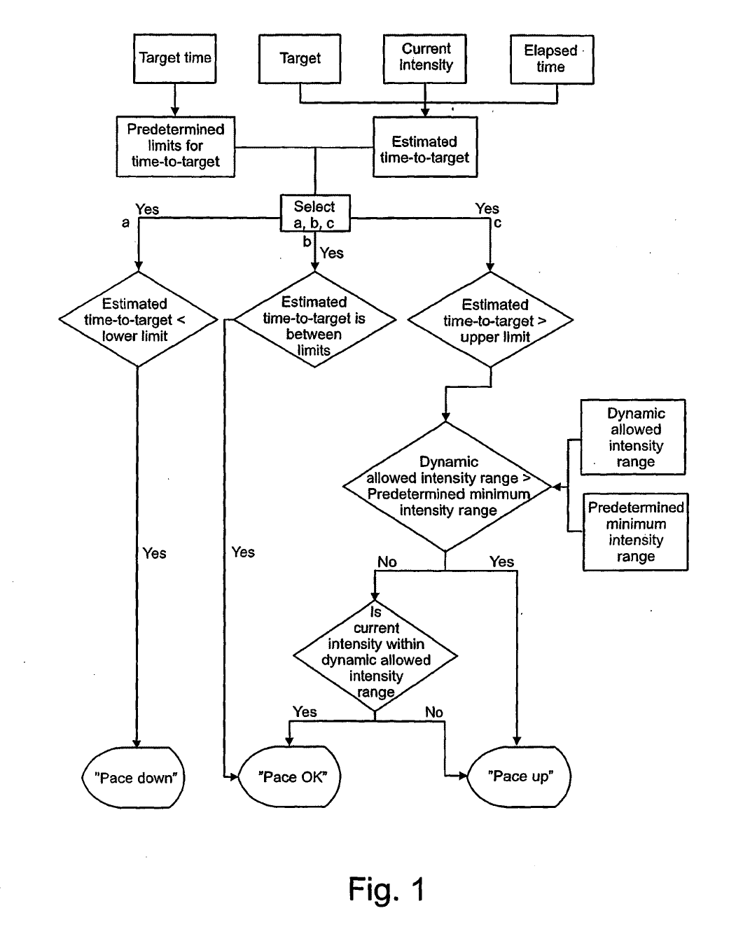

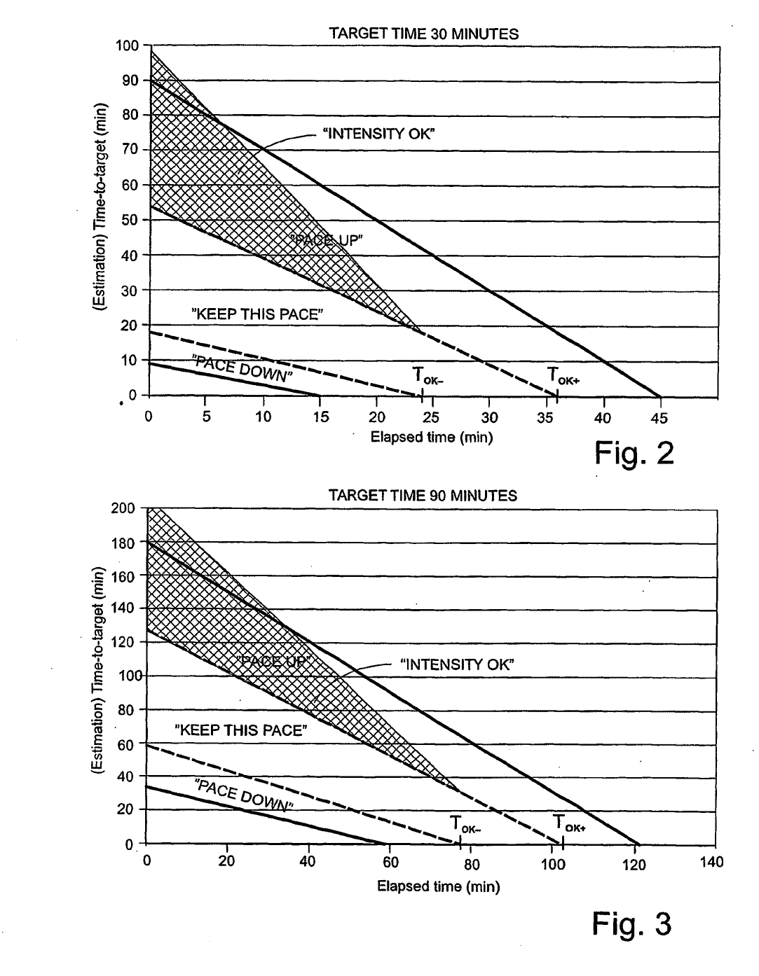

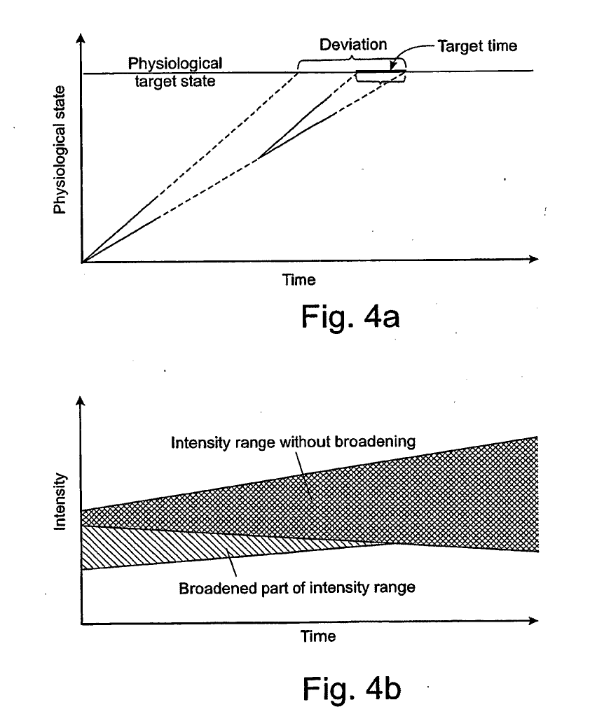

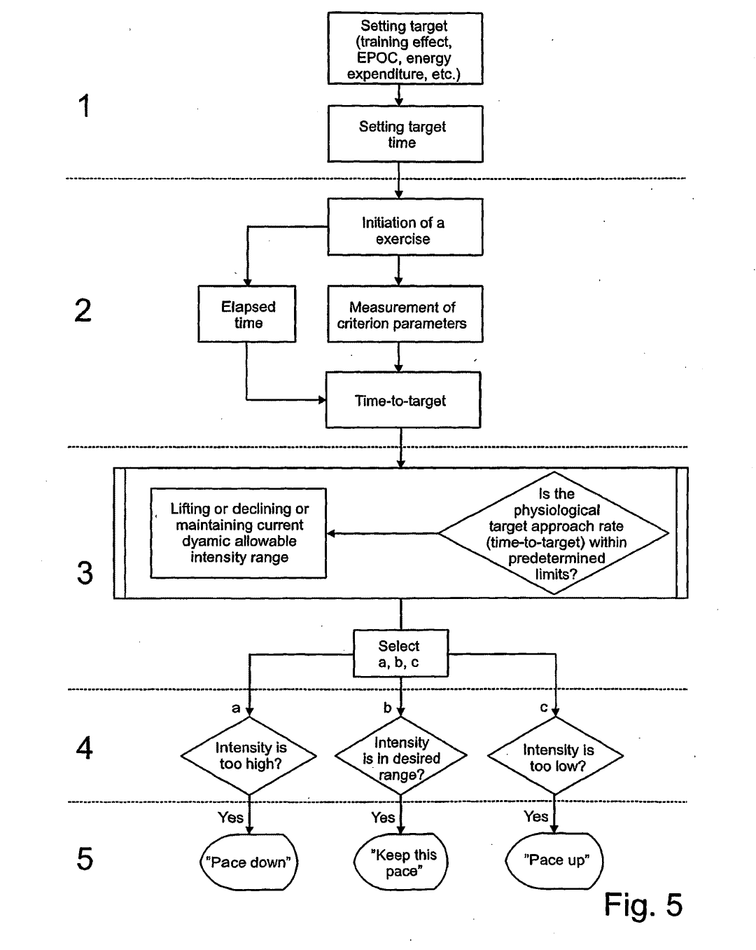

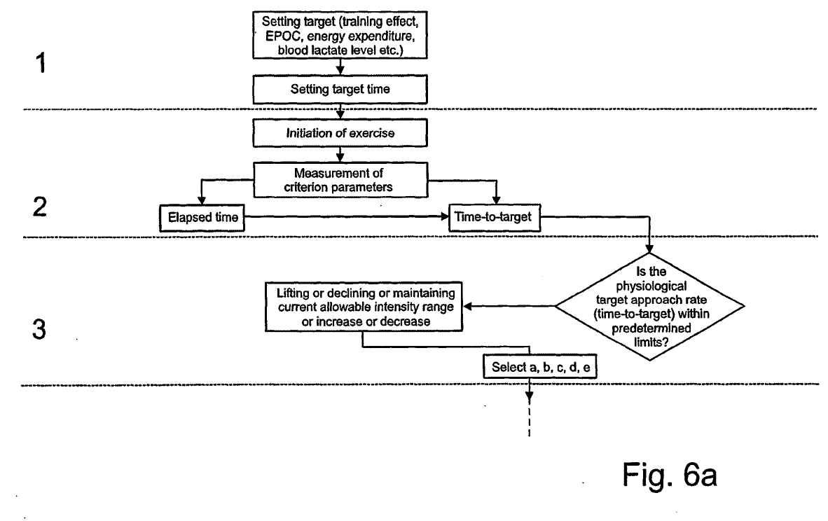

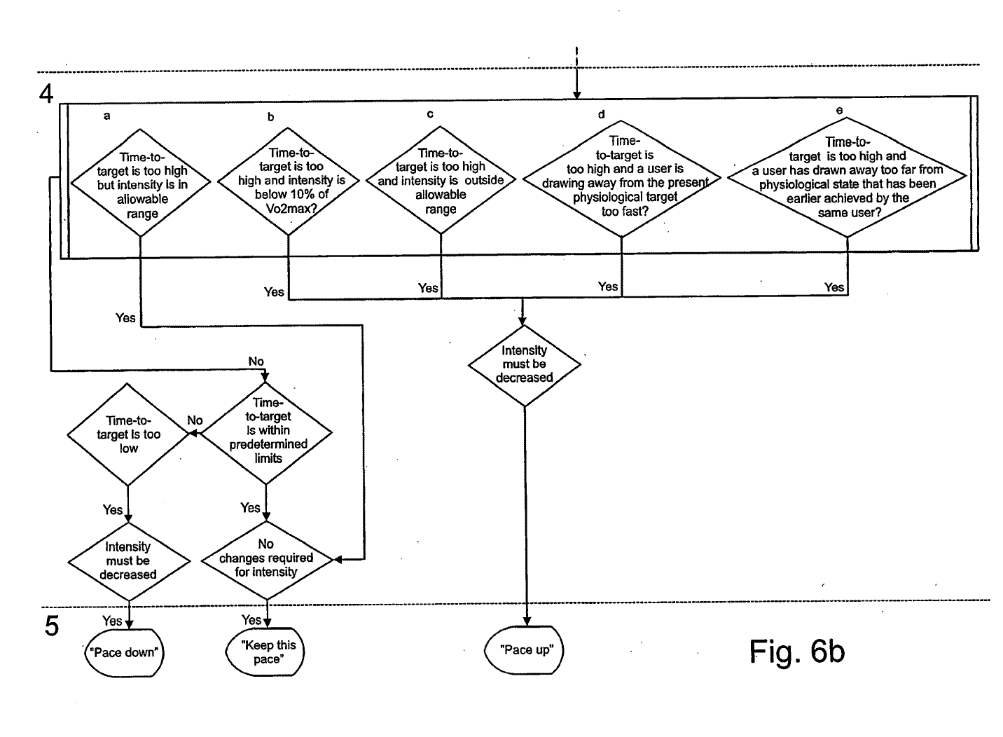

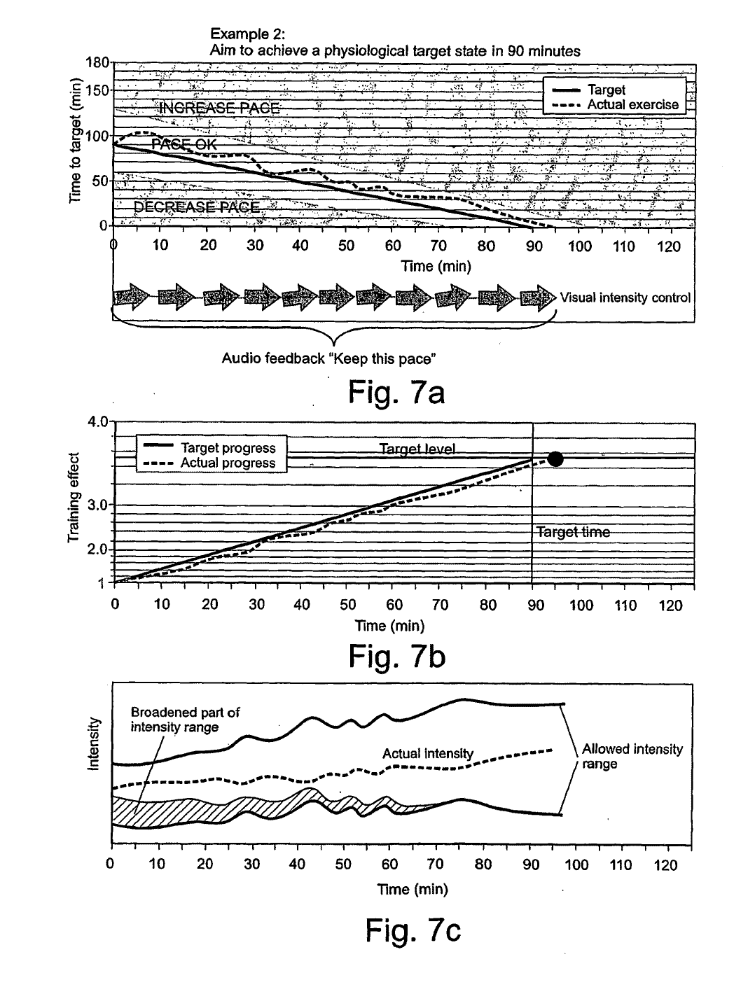

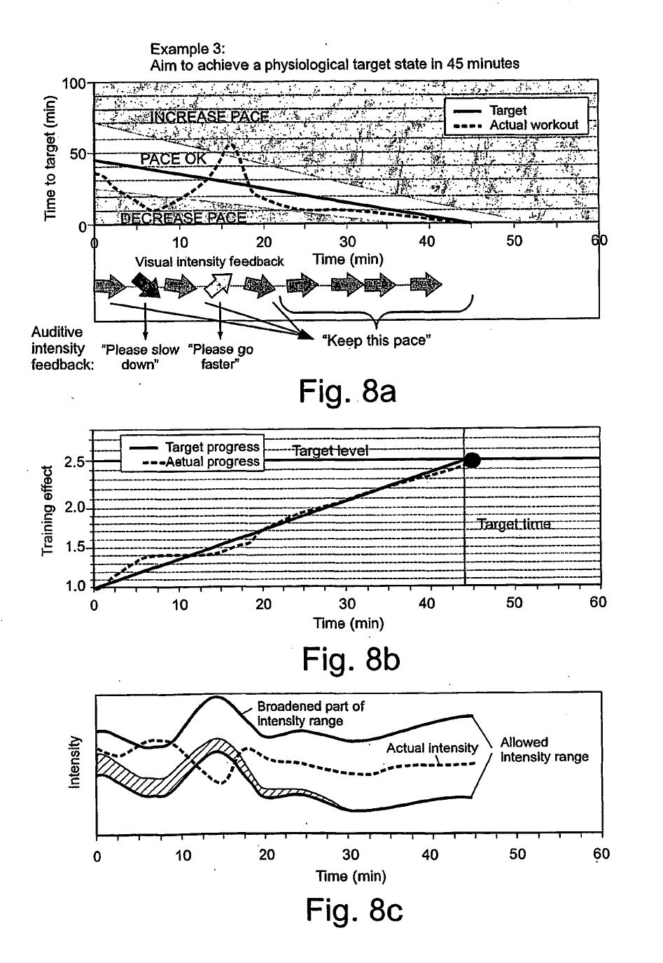

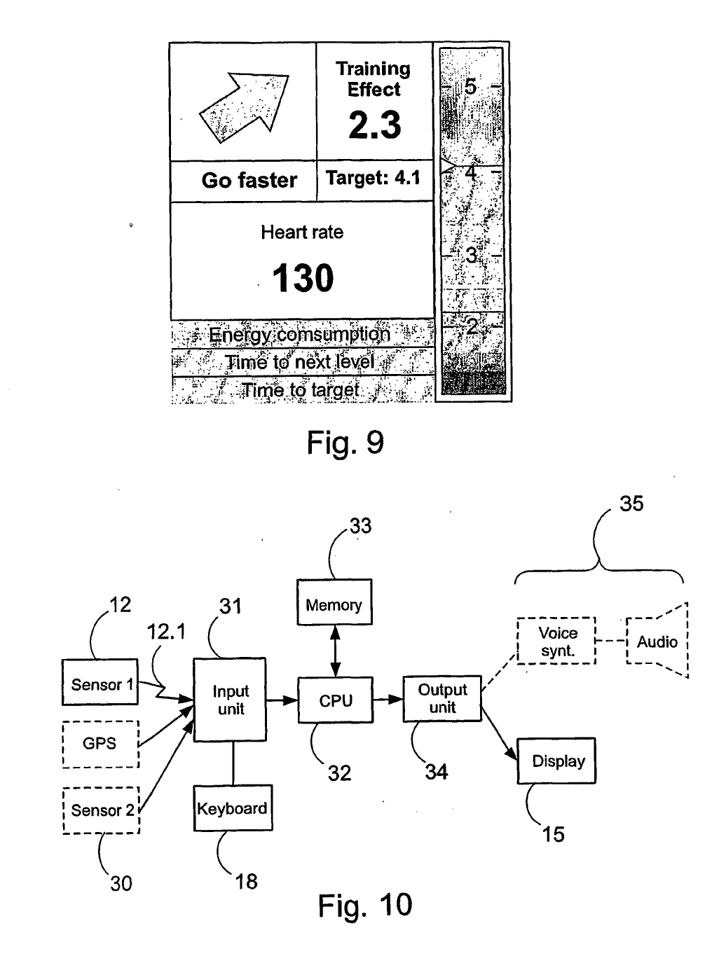

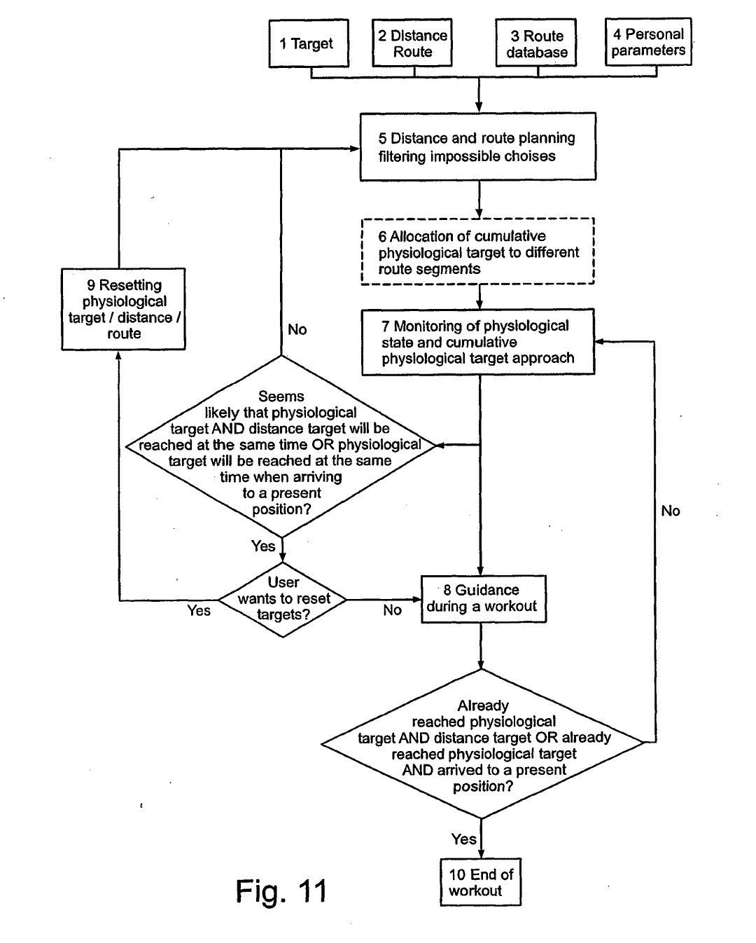

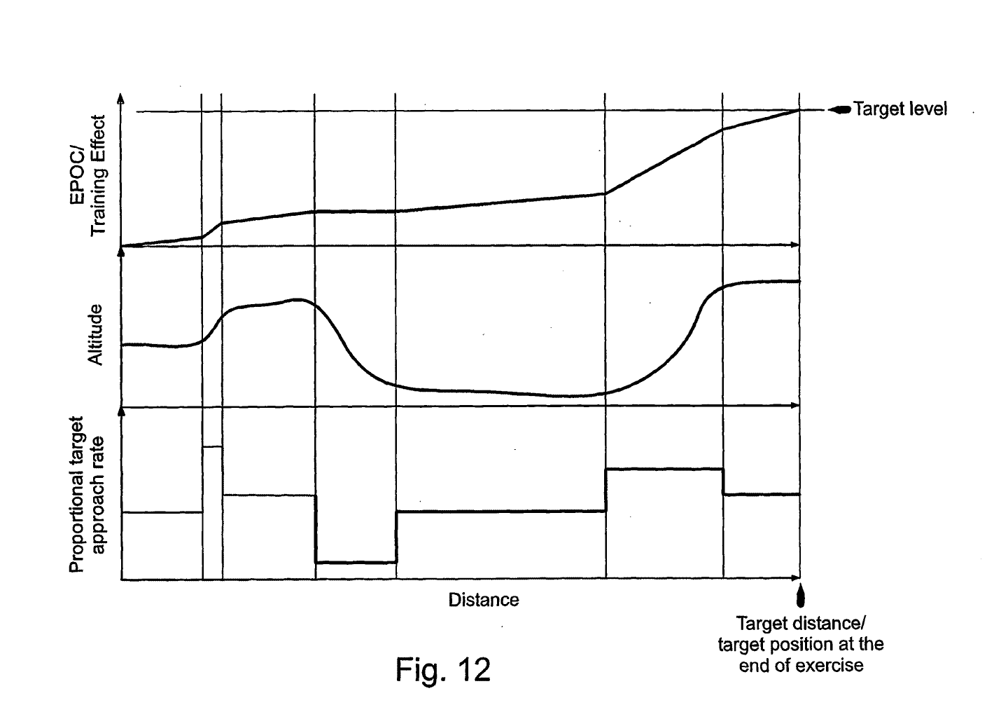

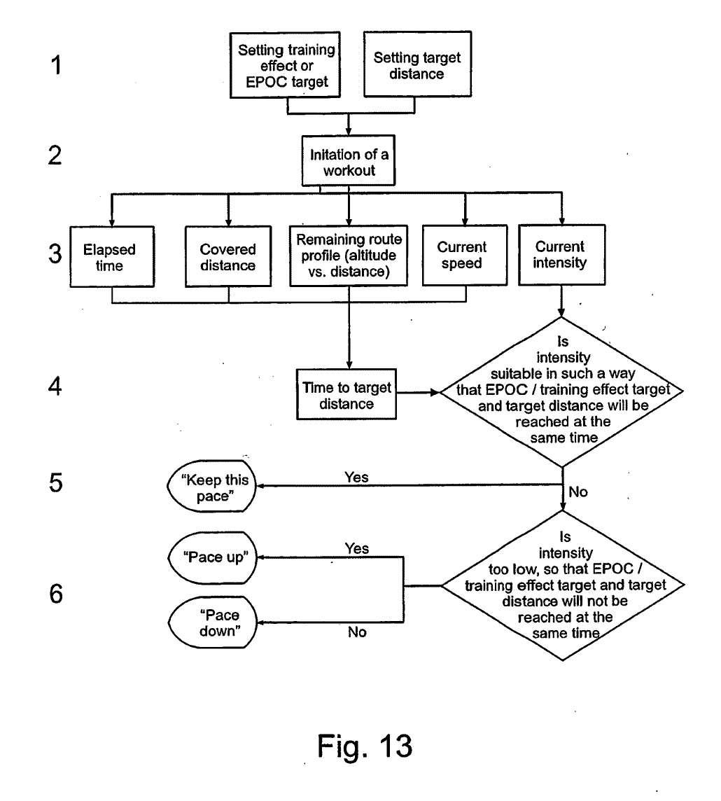

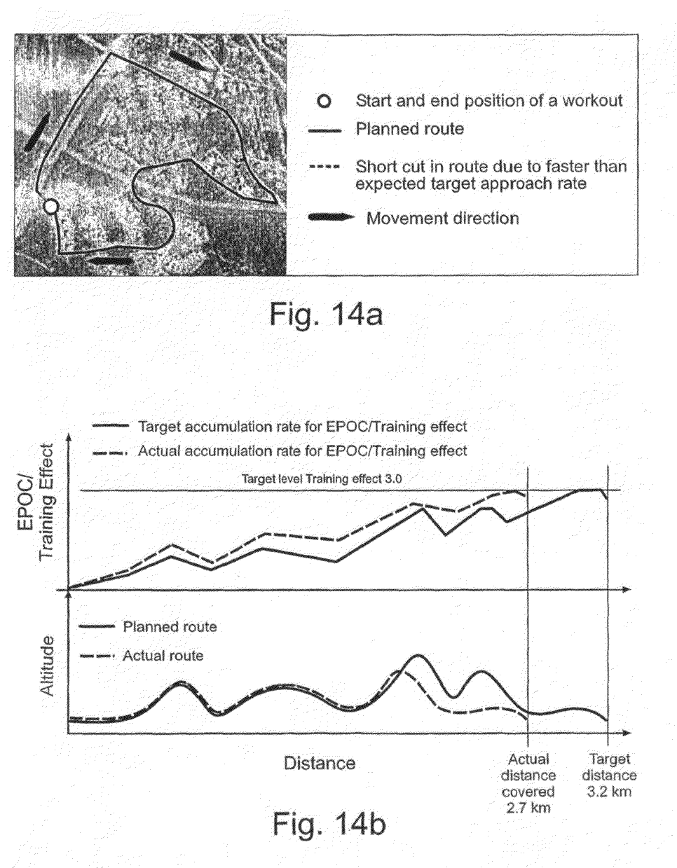

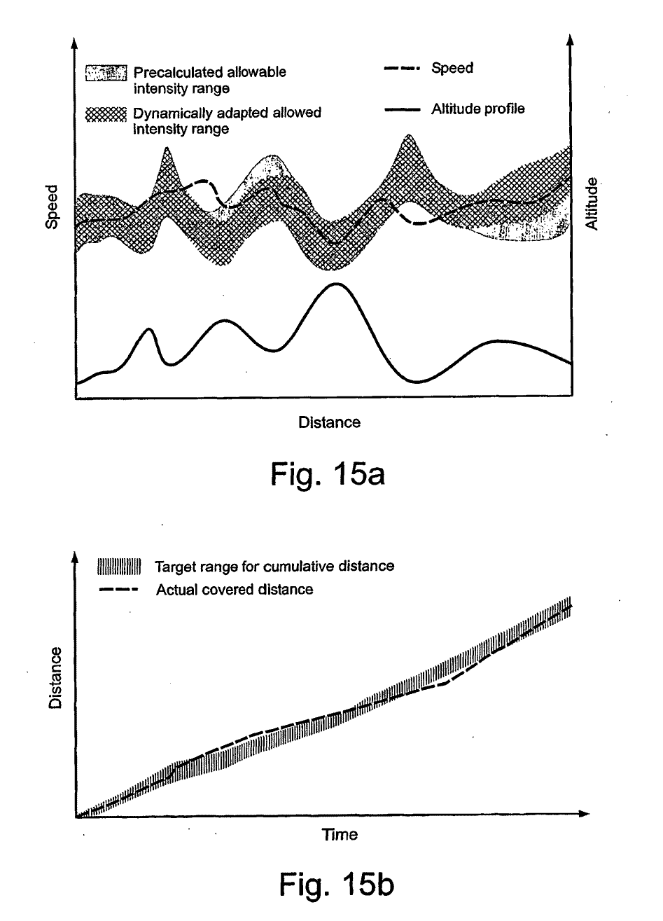

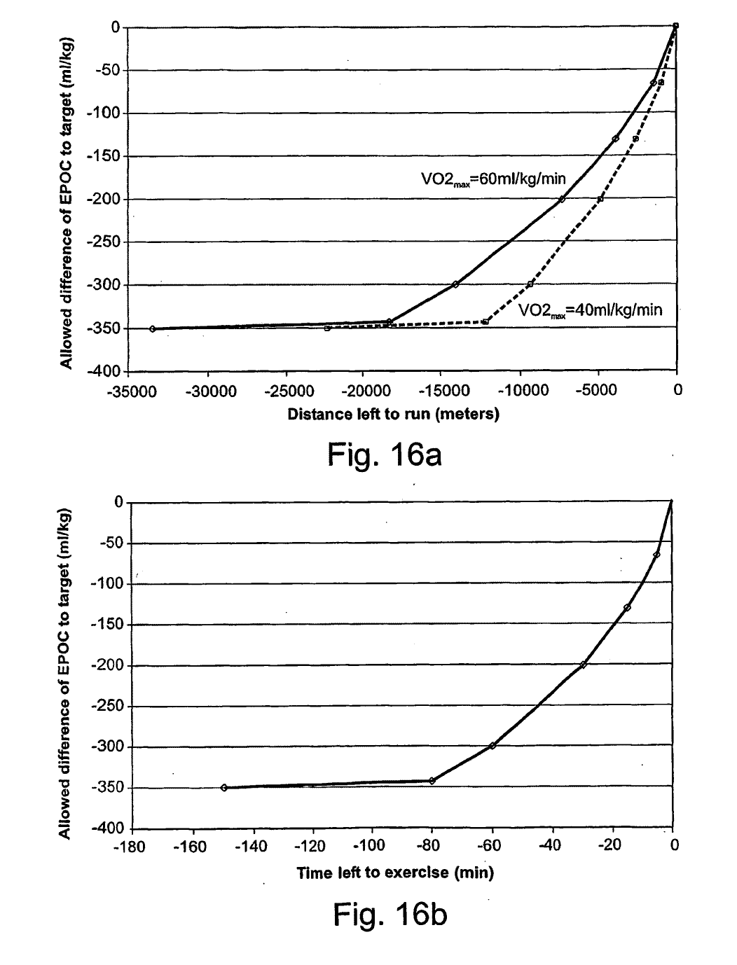

(wherein, R₁ represents a quadrivalent aromatic group which is a residual group of a dicarboxylic acid dianhydride ingredient (pyromellitic acid anhydride, 3,3′,4,4′-biphenyltetracarboxylic acid dianhydride, 3,3′,4,4′-benzophenontetracarboxylic acid dianhydride or 2,3,6,7-naphthalenetetracarboxylic acid dianhydride), R₂ represents a divalent aromatic group which is a residual group of a diamine ingredient (1,3-bis-(3-aminophenoxy)benzene, 3,3′-diamino-4,4′-dihydroxydiphenylsulfone or/and 4,4′-diamino-3,3′,5,5′-tetraethyldiphenylmethane), and n1 represents a repeating number) as a primer resin; and copper foils and laminated sheets having said polyimide layer as a primer have high adhesive strength and are suitable for flexible printed wiring boards.

### TECHNICAL FIELD

The present invention relates to a primer resin which can give good adhesiveness with resin substrates for flexible printed wiring boards such as polyimide film substrates by using a copper foil which has been coated thinly with a solvent-soluble polyimide resin directly on its surface and dried without roughening treatment, a copper foil with a layer of the primer resin and a method for producing the same, and a laminated sheet using said copper foil.

### BACKGROUND ART

Typically, a polyimide film is laminated with a metal foil (mainly, copper foil) to be used as a one- or double-sided flexible copper clad laminate, a flexible printed wiring substrate and a multilayer printed wiring substrate. Particularly, copper clad laminates referred to as double layer CCL are directly laminated with a polyimide film and a copper foil without involving an adhesive layer and therefore very useful in terms of wiring miniaturization and substrate heat resistance, and on the other hand they have a problem on the adhesive strength between the polyimide film and the copper foil. Methods for producing a double layer CCL include a casting method (Patent Literature 1) where a polyimide precursor is coated on a copper foil followed by ring closure by heating to obtain a copper foil with a polyimide layer, a lamination method (Patent Literature 2) by heating and pressing a thermoplastic polyimide film and a copper foil to obtain a laminate, a method where a spatter layer is provided on a polyimide film surface followed by plating with a copper foil, and the like. At the present, the casting method is a mainstream.

On the other hand, to copper foil which has been used in production of conventional printed wiring boards as disclosed in many literatures, roughening treatment to form bumps is applied by a method such as adhesion of fine copper particles to its one side or electrolyzing the copper surface. The purpose of this roughening treatment is to enhance adhesive strength. In laminating a substrate resin such as prepregs and a copper foil by pressure, bumps of said copper foil are embedded in the substrate resin and thus anchor effect is generated. As a result, the adhesive strength between the copper foil and the substrate resin is enhanced. However, copper foil surfaces are typically coated with an amine compound such as rust-preventive agent, a long chain alkyl compound or a silicone-based compound as a surface treatment agent, and therefore adhesive strength between the copper foil and the polyimide resin substrate in a double layer CCL obtained by the casting method of coating a polyimide precursor as it is, cannot be enhanced similarly to the above case of laminating a substrate resin by pressure. Otherwise, removing a surface treatment agent through a complicated process such as degreasing and soft etching processes also causes problems such as corrosion and oxidation because such a copper foil surface is exposed to the atmosphere and a polyimide precursor. Further, there is a problem on adhesive strength in an untreated copper foil which is subjected to no surface treatments such as roughening treatment, rust preventive treatment or the like. In order to solve the problems, there is a case (Patent Literature 5) in which a soluble polyimide resin having high adhesive strength is used for a copper foil having a small bump form, which is however not satisfying for adhesive strength, heat resistance as a substrate, mechanical strength or the like.

### [Patent Literature 1] JP S60-042817

### [Patent Literature 2] JP H07-040626

### [Patent Literature 3] JP H06-006360

### [Patent Literature 4] JP H05-022399

### [Patent Literature 5] JP 2006-082228

### DISCLOSURE OF THE INVENTION

### Problems to be Solved by the Invention

If a copper foil without roughening treatment can be used in production of printed wiring boards, it is possible to omit the roughening treatment process for copper foil and to considerably reduce the production cost. In addition, the over etching time for dissolving the roughening-treated part is not necessary in circuit etching and it is possible to reduce the total etching cost.

In addition, a printed wiring board using a copper foil without roughening treatment has no thickness of the roughness part, which allows formation of finer wiring patterns and smaller electric resistance of wiring surface, and thus it is very useful. Therefore, using a copper foil without roughening treatment in production of printed wiring boards is preferred in terms of both reduction in the production cost and improvement in the performance.

The object of the present invention is to provide a primer resin which can give good adhesiveness between a copper foil and a polyimide resin substrate in copper clad resin substrates for flexible printed wiring boards and the like obtained by a casting method without roughening treatment to copper foil, a copper foil with a layer of the primer resin and a laminated sheet with use thereof.

### Means of Solving the Problems

The present inventors have studied intensively to solve the above problems and completed the present invention.

That is, the present invention relates to:

(1) A copper foil with a primer resin layer having a polyimide resin layer represented by the following formula (1):

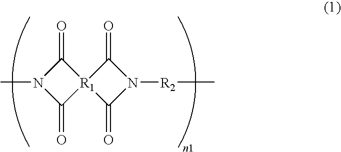

(wherein, R₁ represents one or more quadrivalent aromatic groups selected from the following formula (2):

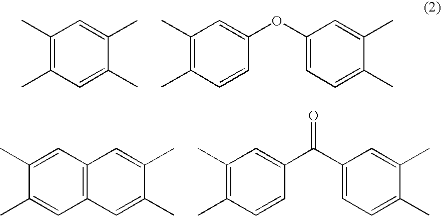

and R₂ represents one or more divalent aromatic groups selected from the following formula (3):

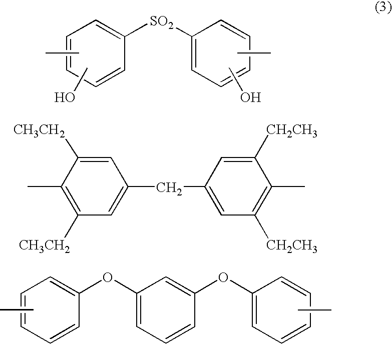

and n1 is a repeating number and represents 10 to 1,000) as a primer resin layer to give adhesiveness with a resin substrate to a copper foil surface without roughening treatment,
(2) A method for forming a copper foil with a primer resin layer characterized in that the polyimide resin according to the above (1) is dissolved in a solvent having one or more selected from the group consisting of N-methyl-2-pyrrolidone, N,N-dimethylacetoamide, methylbenzoate, valerolactone and butyrolactone to give a primer resin solution which is then coated on a copper foil and dried,
(3) A copper clad laminate for flexible printed wiring boards having the polyimide resin layer according to the above (1) as a primer resin layer,
(4) The copper foil with a primer resin layer according to the above (1), wherein Rz as a roughness of copper foil surface without roughening treatment is 2 μm or less,
(5) The copper foil with a primer resin layer according to the above (4), wherein the surface of the copper foil having the primer resin layer is a copper foil surface having a layer plated with one or more metals selected from the group consisting of nickel, iron, zinc, gold, silver, aluminum, chrome, titanium, palladium and tin,
(6) The copper foil with a primer resin layer according to the above (4) or (5), wherein the copper foil surface having a primer resin layer is a copper foil surface having a surface roughness, Rz, of 2 μm or less, or a copper foil surface having a layer plated with a metal on said copper foil surface, or a copper foil surface having a silane coupling agent layer on either of them,
(7) The copper foil with a primer resin layer according to the above (1) having a polyimide resin layer represented by the formula (1) wherein R₁ is one or more quadrivalent aromatic groups selected from the following formula (2-1):

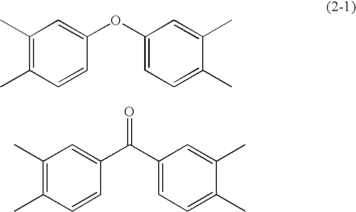

(8) The copper foil with a primer resin layer according to the above (1), wherein the polyimide resin represented by the formula (1) is obtained by (a) using 4,4′-oxydiphthalic acid anhydride as a dicarboxylic acid dianhydride ingredient and using 1,3-bis-(3-aminophenoxy)benzene alone, 3,3′-diamino-4,4′-dihydroxydiphenylsulfone alone or both 1,3-bis-(3-aminophenoxy)benzene and 3,3′-diamino-4,4′-dihydroxydiphenylsulfone as a diamine ingredient; or by (b) using 3,4,3′,4′-benzophenontetracarboxylic acid dianhydride as a dicarboxylic acid dianhydride ingredient and using 4,4′-diamino-3,3′,5,5′-tetraethyldiphenylmethane as a diamine ingredient,
(9) Use of the polyimide resin represented by the formula (1) according to the above (1) for a primer resin varnish to give adhesiveness between a copper foil without roughening treatment and a resin substrate,
(10) A primer resin characterized by containing the polyimide resin represented by the formula (1) according to the above (1).

### EFFECT OF THE INVENTION

The polyimide resin represented by the above formula (1) of the present invention is already cyclized and therefore has, unlike in the case where a precursor is coated and then cyclized on copper foil followed by imidization, almost no curing shrinkage, smaller shrinkage stress when coated on copper foil and dried, and high adhesive strength with copper foil, and causes no corrosion of copper foil and thus is effective as a rust prevent treating agent. In addition, in a copper clad laminate for flexible printed wiring boards, when a substrate resin layer is formed on said polyimide resin layer using a polyimide precursor solution, the adhesive strength between the polyimide resin of the present invention as a primer resin and the polyimide substrate resin layer formed from said polyimide precursor is also higher; and thus the polyimide resin represented by the formula (1) is very excellent as a primer resin. Therefore, the primer resin and the copper foil with a primer resin layer of the present invention are extremely useful in the field of electric materials such as electric substrates.

### BEST MODE FOR CARRYING OUT THE INVENTION

In the present invention, a copper foil surface on which the primer resin layer is formed, as long as without roughening treatment, may be an untreated surface; or may be plated with one or more metals selected from, for example, nickel, iron, zinc, gold, silver, aluminum, chrome, titanium, palladium or tin; or may be surface-treated with an agent such as silane coupling agent on a copper foil surface untreated or plated with the above metals. Preferable metals for plating treatment are one or more selected from nickel, iron, zinc, gold or aluminum, and more preferably nickel or aluminum. In addition, preferable are optionally one or more selected from nickel, iron, zinc, gold or tin.

Therefore, for the copper foil with a primer resin layer in the present invention, the polyimide resin layer (primer resin layer) represented by the above formula (1) may be formed directly on an untreated surface of copper foil; or the polyimide resin layer represented by the above formula (1) may be formed on a copper foil surface treated with the above agent, via said treated layer, for example, the above layer plated with metals or treated with a silane coupling agent. However, the primer resin layer is provided for strong adhesion between a copper foil and a resin substrate and therefore, usually, provided directly on a copper foil surface without involving another resin layer or the like which decreases the adhesiveness between copper foil and resin substrates, other than the above layer plated with metals or treated with a silane coupling agent.

The primer resin of the present invention is not particularly limited as long as it is a polyimide resin having an imide segment containing a structure represented by the following formula (4):

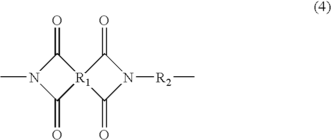

(wherein, R₁ and R₂ have the same meanings as in the above formula (1)) and the repeating number is preferably 10 to 1,000. If the repeating number is less than 10, it is more difficult that heat resistance and mechanical strength, which polyimide itself has, are exhibited, as well as it is more likely that the copper foil surface is affected by terminal groups (amino group or carboxy group) of the polyimide resin. On the other hand, the repeating number is more than 1,000, the viscosity in a solution is higher and therefore it is difficult to form a layer and also the adhesiveness with copper foil surface is decreased. Taking these disadvantages into account, the above repeating number is preferably 50 to 500. Further, the weight average molecular weight of the polyimide resin is preferably about 5,000 to 500,000 in terms of workability. More preferable is about 50,000 to 200,000. Further preferable is about 50,000 to 150,000.

Primer layers or films of conventional polyimide resins were made typically by coating a varnish containing polyamic acid of the precursor on a substrate and dried followed by heating treatment for ring closure reaction of the precursor. On the other hand, in the present invention, the primer resin itself is a polyimide resin where the polyamic acid is cyclized, and therefore the primer layer of polyimide can be obtained only by drying after said primer resin solution (solution dissolving a polyimide resin: primer resin varnish) is coated directly on a copper foil.

The primer resin of the present invention is obtained typically by condensation reaction of one or more among tetracarboxylic acid dianhydrides represented by the following formula (5):

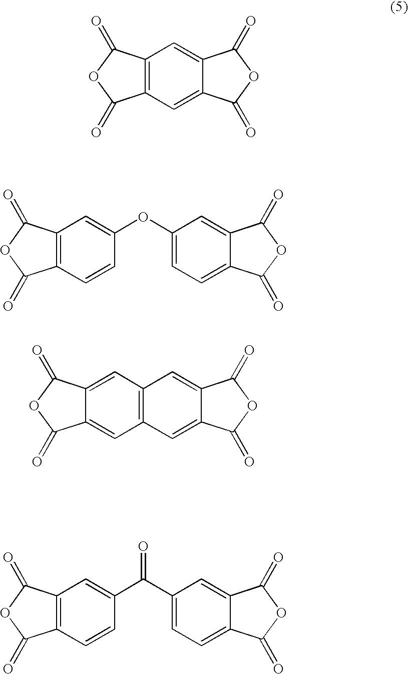

with one or more among diamines represented by the following formula (6):

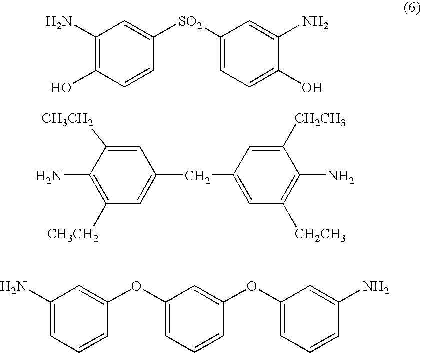

to give polyamic acid which is then cyclized. The ring closure reaction of the polyamic acid is preferably carried out in a solvent dissolving said polyamic acid, for example, a solvent containing one or more selected from the group consisting of N-methyl-2-pyrrolidone, N,N-dimethylacetoamide, methylbenzoate, valerolactone and butyrolactone. Thus obtained polyimide solution can be coated on a copper foil similarly as a usual varnish for use.

For this varnish, a solution dissolving typically 1 to 50% by weight, preferably 5 to 30% by weight of the polyimide resin in a solvent is easily handled.

Preferable tetracarboxylic acid dianhydrides in the present invention include, among the above, 4,4′-oxydiphthalic acid anhydride or 3,4,3′,4′-benzophenontetracarboxylic acid dianhydride, and more preferable is 4,4′-oxydiphthalic acid anhydride. In addition, as a diamine ingredient, any diamine of the above three kinds can be used in combination of the above tetracarboxylic acid dianhydrides, and more preferable diamines include 1,3-bis-(3-aminophenoxy)benzene or 3,3′-diamino-4,4′-dihydroxydiphenylsulfone. With regard to preferable combinations with tetracarboxylic acid dianhydride, 1,3-bis-(3-aminophenoxy)benzene or 3,3′-diamino-4,4′-dihydroxydiphenylsulfone are preferable for 4,4′-oxydiphthalic acid anhydride, and in particular, 1,3-bis-(3-aminophenoxy)benzene alone or combination use of 1,3-bis-(3-aminophenoxy)benzene and 3,3′-diamino-4,4′-dihydroxydiphenylsulfone is more preferable. Further, 4,4′-diamino-3,3′,5,5′-tetraethyldiphenylmethane is preferable for 3,4,3′,4′-benzophenontetracarboxylic acid dianhydride. In the above, when a diamine ingredient is used in combination, the use rate of 1,3-bis-(3-aminophenoxy)benzene and 3,3′-diamino-4,4′-dihydroxydiphenylsulfone is not particularly limited, but typically the former is about 100 to 10% by mol and the latter is about 0 to 90% by mol.

The above polyimide resin solution containing a polyimide resin obtained from these combinations is more preferable as a varnish (particularly primer resin varnish) to be coated on the above copper foil

The ring closure reaction by heating can be carried out using the above polar solvent alone, but is preferably carried out while removing water by-produced from the reaction system during the reaction by using a mixed solvent where a small amount of a nonpolar solvent having a relatively low boiling point is added such as toluene, xylene, hexane, cyclohexane and heptane. The reaction temperature is preferably 150 to 220° C., and particularly preferable is 180 to 200° C. The reaction time is preferably 2 to 10 hours, and particularly preferable is 5 to 8 hours. The addition amount of nonpolar solvent is preferably 5 to 20% by weight to the reaction solvent.

The repeating number of the polyimide resin can be controlled by the molar ratio of a tetracarboxylic acid dianhydride ingredient to a diamine ingredient, and for example, the repeating number can reach about 100 by reaction of tetracarboxylic acid dianhydride ingredient:diamine ingredient=1.00 mol:1.01 mol or 1.01 mol:1.00 mol. In addition, more repeating units can be obtained in that the use rate of a tetracarboxylic acid dianhydride ingredient to a diamine ingredient is closer to equimolar than the above rate, and fewer repeating units can be obtained in that the difference of the both numbers in the above mole ratio is larger.

To a primer resin (the above polyimide resin for a primer resin) and a solution thereof to be used in the present invention, various additives can be added if necessary, within the range for achievement of the intended adhesive strength and rust preventive effect on copper foil. They include, for example, organic additives such as aromatic polyamide resin, epoxy resin and phenol resin, inorganic additives such as silica compounds, pigments, dyes, antihalation agents, fluorescent brightening agents, surfactants, leveling agents, plasticizers, flame retarders, antioxidants, fillers, antistatic agents, viscosity modifiers, imidization catalysts, accelerators, dehydrating agents, retardants for imidization, light stabilizers, photocatalysts, low dielectric materials, conductive materials, magnetic materials or heat decomposable compounds and the like.

The copper foil with a primer resin layer of the present invention can be obtained by coating a polyimide resin solution (primer resin solution) represented by the formula (1) on a copper foil and then drying. More specifically, the above primer resin solution is coated typically on one side of a copper foil without roughening treatment (said copper foil surface may be plated with a metal or subjected to silane coupling treatment) and then dried so as that the thickness as the primer resin layer (thickness of the polyimide resin layer after drying) is, for example, 0.5 to 20 μm, preferably 1 to 10 μm and more preferably 1 to 5 μm, and thus said polyimide layer is formed on a copper foil in order to obtain the copper foil with a primer resin layer of the present invention. For example, 20% by weight of the primer resin solution is coated in a thickness of 10 μm and dried at 80 to 200° C. for 5 to 60 minutes, preferably at 130 to 150° C. for 10 to 30 minutes in order to obtain a primer layer having a thickness of about 2 μm.

The heat source for drying may be hot air or a far infrared heater, however, it is advisable to use hot air and a far infrared heater in combination in terms of prevention of solvent vapor retention and heat conduction to the inside of resin.

The copper clad laminate for flexible printed wiring boards provided with the primer resin layer of the present invention is a copper clad laminate for flexible printed wiring boards having the above primer layer between a copper foil and a resin substrate (typically polyimide resin substrate), where the adhesive strength to both the copper foil and the resin substrate is preferably 1 N/mm or more, more preferably 1.2 N/mm or more, further preferably 1.5 N/mm or more and typically 3 N/mm or less.

A preferable copper foil with a primer resin layer of the present invention can be obtained by using, as a copper foil on which the above primer resin layer is formed, a copper foil having a surface roughness, Rz, of 2 μm or less without roughening treatment; a copper foil having a layer plated with one or more metals selected from the group consisting of nickel, iron, zinc, gold, silver, aluminum, chrome, titanium, palladium and tin on said copper foil surface; or a copper foil having a layer treated with a silane coupling agent on said copper foil surface without roughening treatment or a copper foil surface with said layer plated with a metal.

The metal plated layer of said copper foil surface is obtained by electrolytic or non electrolytic plating in a solution where said metals are ionized, whose thickness is preferably 10 to 300 nm. In addition, the layer treated with a silane coupling agent is obtained typically by coating a silane coupling agent on the copper foil surface. As the silane coupling agent, various commercially available silane coupling agents can be used such as amino and epoxy silane coupling agents and the like (for example, KBM series manufactured by Shin-Etsu Chemical Co., Ltd.), whose thickness is preferably 1 to 50 nm.

### EXAMPLES

Hereinafter, the present invention will be explained more specifically by Examples but not limited thereto.

The method for measuring change of copper foil surfaces in copper foils with a primer resin layer and adhesive strength of copper clad laminates is as follows.

### 1. Change of Copper Foil Surface

Change of a copper foil surface of copper foil with a primer resin layer was determined by visual observation of states of the copper foil surface immediately after formation of a primer resin layer and 1 week after.

### 2. Adhesive Strength of Primer Resin Layer and Copper Foil in Copper Clad Laminate.

The copper foil side of each copper clad laminate obtained in Examples was masked with a 10 mm wide pattern, the copper foil except for the masked part was dissolved to form a 10 mm wide copper foil pattern. The polyimide substrate side was bonded to a 0.3×70×150 mm iron plate with a bonding sheet (trade name: Cansuper, manufactured by Paltek Corporation) and only the end of the 10 mm wide copper foil is peeled off the resin with a cutter knife for use in measurement by a measuring machine in order to measure the adhesive strength between the 10 mm wide copper foil and the resin in the direction of 180 degrees using a Tensilon tester (manufacture by A&D Company: Orientec Co., LTD.)

### Synthesis Example 1

In a 300 ml reactor equipped with a thermometer, a reflux cooler, a Dean-Stark trap, a powder inlet, a nitrogen inlet device and a stirring device, 24.84 g (0.085 mol) of 1,3-bis-(3-aminophenoxy)benzene (APB-N: manufactured by Mitsui Chemical, Inc.; molecular weight: 292.34; hereinafter referred to as APB-N for simplicity) as a diamine ingredient was charged and then 38.42 g of methylbenzoate as a solvent was added thereto while flowing dry nitrogen, followed by stirring at 60° C. for 30 minutes. Then, thereto were added 26.88 g (0.087 mol) of 4,4′-oxydiphthalic acid anhydride (ODPA: manufactured by MANAC Incorporated; molecular weight: 310.22; hereinafter referred to as ODPA for simplicity) as a dicarboxylic acid dianhydride ingredient, 57.63 g of gamma-butyrolactone as a solvent, 0.868 g of gamma-valerolactone and 1.371 g of pyridine as catalysts, and 22.2 g of toluene as a dehydrating agent. The inside of the reactor was heated to 180° C. and ring closure reaction by heating was carried out for 6 hours while distilling off generated water through a fractionating column. After completion of the imidization reaction, the reaction liquid was cooled to 80° C. or lower and then filtrated under pressure using a 3 μm pore size filter: Teflon® (hereinafter, superscript ® stands for registered trademark), in order to obtain 168 g of a solution dissolving a polyimide resin (the weight average molecular weight was 96,600) represented by the following formula (7):

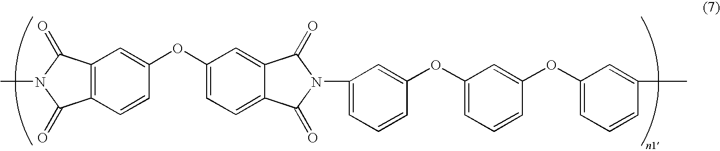

(wherein, n1′ represents a repeating number)
at a concentration of 34% by weight in a mixed solvent of gamma-butyrolactone and methylbenzoate. The rotational viscosity when 1.00 ml of this primer resin solution was measured at 25° C. using an E-type rotational viscometer was 26.8 Pa·s.

### Synthesis Example 2

In a 500 ml reactor equipped with a thermometer, a reflux cooler, a Dean-Stark trap, a powder inlet, a nitrogen inlet device and a stirring device, 14.67 g (0.050 mol) of 1,3-bis-(3-aminophenoxy)benzene (APB-N) and 26.13 g (0.093 mol) of 3,3′-diamino-4,4′-dihydroxydiphenylsulfone (ABPS: manufactured by Nippon Kayaku Co., Ltd.; molecular weight: 280.3) as diamine ingredients were added and 64.02 g of methylbenzoate as a solvent was added thereto while flowing dry nitrogen, followed by stirring at 60° C. for 30 minutes. Then, thereto were added 45.38 g (0.146 mol) of 4,4′-oxydiphthalic acid anhydride (ODPA) as a dicarboxylic acid dianhydride ingredient, 96.03 g of gamma-butyrolactone as a solvent, 1.465 g of gamma-valerolactone and 2.314 g of pyridine as catalysts, and 32.5 g of toluene as a dehydrating agent. The inside of the reactor was heated to 180° C. and ring closure reaction by heating was carried out for 6 hours while distilling off generated water through a fractionating column. After completion of the imidization reaction, the reaction liquid was cooled to 80° C. or lower and then filtrated under pressure using a 3 μm pore size filter: Teflon®, in order to obtain 279 g of a solution dissolving a polyimide resin (the weight average molecular weight was 87,000) represented by the following formula (8):

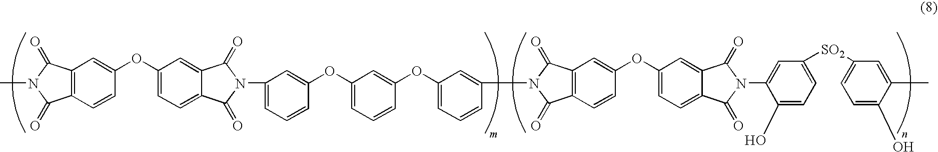

(wherein, m and n are respectively a total number of each segment in a molecule, the rate of m and n is m:n=35:65, each segment in parentheses arranged in any order) at a concentration of 34% by weight in gamma-butyrolactone and methylbenzoate. The rotational viscosity when 1.00 ml of this polyimide solution was measured at 25° C. using an E-type rotational viscometer was 23.2 Pa·s.

### Synthesis Example 3

In a 500 ml reactor equipped with a thermometer, a reflux cooler, a Dean-Stark trap, a powder inlet, a nitrogen inlet device and a stirring device, 49.072 g (0.158 mol) of Kayabond® C-300S (4,4′-diamino-3,3′,5,5′-tetra ethyldiphenylmethane, manufactured by Nippon Kayaku Co., Ltd.; molecular weight: 310.48) as a diamine ingredient was charged and 390.0 g of N-methyl-2-pyrrolidone as a solvent was added while flowing dry nitrogen, followed by stirring at 60° C. for 30 minutes. Then, thereto were added 50.928 g (0.158 mol) of BTDA (3,4,3′,4′-benzophenontetracarboxylic acid dianhydride, manufactured by Degussa; molecular weight: 322.23) as a dicarboxylic acid dianhydride ingredient and 30.0 g of toluene as a dehydrating agent. The inside of the reactor was heated to 180° C. and ring closure reaction by heating was carried out for 6 hours while distilling off generated water through a fractionating column. After completion of the imidization reaction, the reaction liquid was cooled to 80° C. or lower and then filtrated under pressure using a 3 μm pore size filter: Teflon®, in order to obtain 500 g of a solution dissolving a polyimide resin (weight average molecular weight: 72,000) represented by the following formula (9):

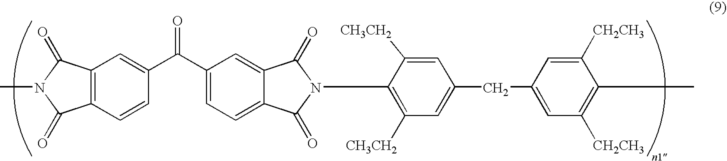

(wherein, n1″ represents a repeating number)
at a concentration of 20% by weight in N-methyl-2-pyrrolidone.

The rotational viscosity when 1.00 ml of this polyimide solution was measured at 25° C. using an E-type rotational viscometer was 870 mPa·s.

### Example 1

N-methyl-2-pyrrolidone was added to the polyimide solution (primer resin solution) obtained in Synthesis Example 1 in order that the solid content was 5% by weight. Using an automatic applicator (manufactured by Yasuda Seiki Seisakusho, Ltd.), the solution was coated in a thickness of 28 μm on a 17 μm thick rolled copper foil (the surface roughness, Rz, is 2 μm or less) and then dried at 130° C. for 10 minutes to obtain a copper foil with a 1.4 μm thick primer layer of the present invention.

### Example 2

In the same manner as in Example 1 except that the polyimide solution obtained Synthesis Example 2 was used instead of the polyimide solution of Synthesis Example 1 used in Example 1, a copper foil with a 1.4 μm thick primer layer of the present invention was obtained.

### Example 3

Using an automatic applicator (manufactured by Yasuda Seiki Seisakusho, Ltd.), the polyimide solution obtained in Synthesis Example 3 was coated in a thickness of 10 μm on a 17 μm thick rolled copper foil (the surface roughness, Rz, was 2 μm or less) and then dried at 130° C. for 10 minutes to obtain a copper foil with a 2.0 μm thick primer layer of the present invention.

### Example 4

In the same manner as in Example 1 except that instead of the 17 μm thick rolled copper foil (the surface roughness, Rz, is 2 μm or less) used in Example 1, a copper foil with a 170 nm thick nickel-plated layer on the same copper foil was used, a nickel plated copper foil with a 1.4 μm thick primer layer of the present invention was obtained.

### Example 5

In the same manner as in Example 1 except that the soluble polyimide solution obtained in Synthesis Example 2 was used instead of the soluble polyimide solution of Synthesis Example 1 used in Example 1, and instead of the 17 μm thick rolled copper foil having a surface roughness, Rz, of 2 μm or less, a copper foil with a 170 nm thick nickel plated layer on the same copper foil was used, a nickel plated copper foil with a 1.4 μm thick primer layer of the present invention was obtained.

### Example 6

Using an automatic applicator (manufactured by Yasuda Seiki Seisakusho, Ltd.), a solution dissolving a polyimide precursor (weight average molecular weight: 81,000) represented by the following formula (10)

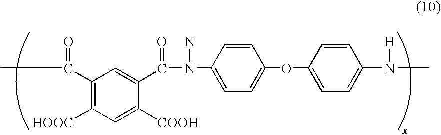

(wherein, x represents a repeating number)
in a mixed solvent of N-methyl-2-pyrrolidone and N,N-dimethylacetoamide (polyimide precursor solution), KAYAFLEX KPI-100 (which is a trade name, manufactured by Nippon Kayaku Co., Ltd.), was coated in a thickness of 100 μm on the primer layer side of the copper foil with a primer layer obtained in Example 1, and then dried at 130° C. for 10 minutes. Subsequently, the temperature was raised to 350° C. over 2 hours under nitrogen atmosphere and was further kept at 350° C. for 2 hours to carry out the ring closure reaction. Then, the product was cooled to room temperature to obtain a copper clad laminate for flexible printed wiring boards of the present invention having a polyimide resin substrate on the primer resin layer. The resin layer (the total of the primer layer and the substrate polyimide layer) had a thickness of 12 μm.

### Example 7

Using the copper foil with a primer layer obtained in Example 2, a copper clad laminate for flexible printed wiring boards of the present invention was obtained in the same manner as in Example 6. The resin layer (the total of the primer layer and the substrate polyimide layer) had a thickness of 12 μm.

### Example 8

Using the copper foil with a primer layer obtained in Example 3, a copper clad laminate for flexible printed wiring boards of the present invention was obtained in the same manner as in Example 6. The resin layer (the total of the primer layer and the substrate polyimide layer; same below) had a thickness of 14 μm.

### Example 9

Using the copper foil with a primer layer obtained in Example 4, a copper clad laminate for flexible printed wiring boards of the present invention was obtained in the same manner as in Example 6. The resin layer had a thickness of 12 μm.

### Example 10

Using the copper foil with a primer layer obtained in Example 5, a copper clad laminate for flexible printed wiring boards of the present invention was obtained in the same manner as in Example 6. The resin layer had a thickness of 13 μm.

### Comparative Example 1

The surface states were observed immediately after a 17 μm thick rolled copper foil (surface roughness, Rz, is 2 μm or less) without a primer layer provided was exposed in the atmosphere; and after the copper foil was exposed in the atmosphere for 1 week, for the differences between them.

### Comparative Example 2

Using an automatic applicator (manufactured by Yasuda Seiki Seisakusho, Ltd.), KAYAFLEX KPI-100 (polyimide precursor solution, manufactured by Nippon Kayaku Co., Ltd.) was coated in a thickness of 100 μm on a 17 μm thick rolled copper foil (the surface roughness, Rz, is 2 μm or less) without a primer layer provided, and then dried at 130° C. for 10 minutes. Subsequently, the temperature was raised to 350° C. over 2 hours under nitrogen atmosphere and further kept at 350° C. for 2 hours to carry out the ring closure reaction. Then, the product was cooled to room temperature to obtain a copper clad laminate for flexible printed wiring boards for comparison. The resin layer had a thickness of 11 μm.

The surface states of Example 1 to 5 and Comparative Example 1 are shown in Table 1 and the measured values of adhesive strength of Example 6 to 10 and Comparative Example 2 are shown in Table 2.

TABLE 1

| | Example 1 | Example 2 | Example 3 | Example 4 | Example 5 | Comp. Exam. 1 |
|---|---|---|---|---|---|---|
| Primer resin | Synthesis | Synthesis | Synthesis | Synthesis | Synthesis | Unused |
| | Example 1 | Example 2 | Example 3 | Example 1 | Example 2 | |
| Copper foil | Untreated | Untreated | Untreated | Ni = 120 nm | Ni = 120 nm | Untreated |
| surface | Rz < 2 μm | Rz < 2 μm | Rz < 2 μm | Rz < 2 μm | Rz < 2 μm | Rz < 2 μm |
| *Noted under | Not | Not | Not | Not | Not | Dotted rust |
| the table | changed | changed | changed | changed | changed | generated |

*Note: Changes on copper foil surface immediately and 1 week after formation of primer resin layer

TABLE 2

| | Example 6 | Example 7 | Example 8 | Example 9 | Example 10 | Comp. Exam. 2 |
|---|---|---|---|---|---|---|
| Substrate resin | Polyimide | Polyimide | Polyimide | Polyimide | Polyimide | Polyimide |
| Primer resin | Synthesis | Synthesis | Synthesis | Synthesis | Synthesis | Unused |
| | Example 1 | Example 2 | Example 3 | Example 1 | Example 2 | |
| Copper foil | Untreated | Untreated | Untreated | Ni = 120 nm | Ni = 120 nm | Untreated |
| surface | Rz < 2 μm | Rz < 2 μm | Rz < 2 μm | Rz < 2 μm | Rz < 2 μm | Rz < 2 μm |
| *Noted below (N/mm) | 1.5 | 1.6 | 1.3 | 1.8 | 1.7 | 0.3 |

*Note: Adhesive Strength

### INDUSTRIAL APPLICABILITY

The primer resin varnish containing the polyimide resin represented by the above formula (1) of the present invention can be just coated and dried on an unroughened copper foil surface to form a primer layer, which has little curing shrinkage. The formed primer layer is high in adhesive strength with a copper foil and does not cause corrosion of copper foil. In addition, the polyimide resin represented by the formula (1) of the present invention bonds strongly a resin substrate and a copper foil in a copper clad laminate for flexible printed wiring boards and thus is very superior as a primer resin. Therefore, the primer resin, the primer resin varnish, the copper foil with a primer resin layer and the copper clad laminate of the present invention are extremely useful in the electric material field such as flexible printed wiring boards.

1. A copper foil with a primer resin layer having a polyimide resin layer represented by the following formula (1): 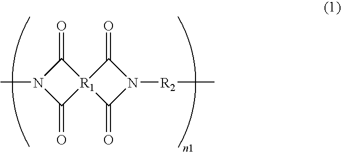
(wherein, R₁ represents one or more quadrivalent aromatic groups selected from the following formula (2): 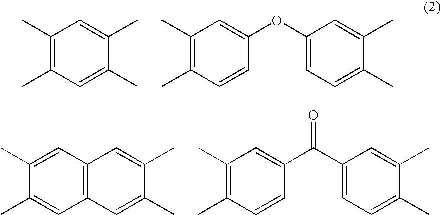
and R₂ represents one or more divalent aromatic groups selected from the following formula (3): 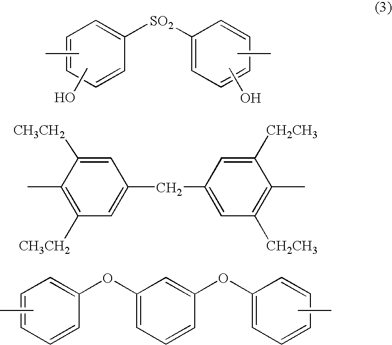
and n1 is a repeating number and represents 10 to 1,000) as a primer resin layer to give adhesiveness with a resin substrate to a copper foil surface without roughening treatment.

2. A method for forming a copper foil with a primer resin layer characterized in that the polyimide resin according to claim 1 is dissolved in a solvent having one or more selected from the group consisting of N-methyl-2-pyrrolidone, N,N-dimethylacetoamide, methylbenzoate, valerolactone and butyrolactone to give a primer resin solution which is then coated on a copper foil and dried.

3. A copper clad laminate for flexible printed wiring boards having the polyimide resin layer according to claim 1 as a primer resin layer.

4. The copper foil with a primer resin layer according to claim 1, wherein Rz as a roughness of copper foil surface without roughening treatment is 2 μm or less.

5. The copper foil with a primer resin layer according to claim 4, wherein the surface of the copper foil having the primer resin layer is a copper foil surface having a layer plated with one or more metals selected from the group consisting of nickel, iron, zinc, gold, silver, aluminum, chrome, titanium, palladium and tin.

6. The copper foil with a primer resin layer according to claim 4 or 5, wherein the copper foil surface having a primer resin layer is a copper foil surface having a surface roughness, Rz, of 2 μm or less, or a copper foil surface having a layer plated with a metal on said copper foil surface, or a copper foil surface having a silane coupling agent layer on either of them.

7. The copper foil with a primer resin layer according to claim 1 having a polyimide resin layer represented by the formula (1) wherein R₁ is one or more quadrivalent aromatic groups selected from the following formula (2-1):

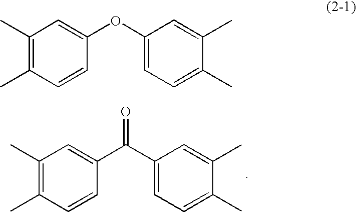

8. The copper foil with a primer resin layer according to claim 1, wherein the polyimide resin represented by the formula (1) is obtained by (a) using 4,4′-oxydiphthalic acid anhydride as a dicarboxylic acid dianhydride ingredient and using 1,3-bis-(3-aminophenoxy)benzene alone, 3,3′-diamino-4,4′-dihydroxydiphenylsulfone alone or both 1,3-bis-(3-aminophenoxy)benzene and 3,3′-diamino-4,4′-dihydroxydiphenylsulfone as a diamine ingredient; or by (b) using 3,4,3′,4′-benzophenontetracarboxylic acid dianhydride as a dicarboxylic acid dianhydride ingredient and using 4,4′-diamino-3,3′,5,5′-tetraethyldiphenylmethane as a diamine ingredient.

9. Use of the polyimide resin represented by the formula (1) according to claim 1 for a primer resin varnish to give adhesiveness between a copper foil without roughening treatment and a resin substrate.

10. A primer resin characterized by containing the polyimide resin represented by the formula (1) according to claim 1.
